(19) United States
(12) Patent Application Publication
(10) Pub. No.: US 2026/0074421 A1
(43) Pub. Date: Mar. 12, 2026

(54) ANTENNA STRUCTURE AND COMMUNICATION DEVICE

(71) Applicant: HUAWEI TECHNOLOGIES CO., LTD., Shenzhen (CN)

(72) Inventors: Viswanadh Ravi Teja Gudivada, Shenzhen (CN); Yi Huang, Shenzhen (CN); YUCHAN YANG, Reading (GB); Hanyang Wang, Shenzhen (CN)

(73) Assignee: HUAWEI TECHNOLOGIES CO., LTD., Shenzhen (CN)

(21) Appl. No.: 19/392,641

(22) Filed: Nov. 18, 2025

Related U.S. Application Data
(63) Continuation of application No. PCT/CN2024/088610, filed on Apr. 18, 2024.

(30) Foreign Application Priority Data
May 19, 2023 (CN) 202310572248.4

(51) Int. Cl. H01Q 5/10; H01Q 1/38; H01Q 3/02; H01Q 13/10

(52) U.S. Cl. CPC H01Q 5/10; H01Q 1/38; H01Q 3/02; H01Q 13/10

(57) ABSTRACT

Embodiments of this application provide an antenna structure and a communication device. The antenna structure includes: a printed circuit board (PCB), which includes a ground plane and a feed part. The feed part is disposed on the PCB. The antenna structure further includes an insulation cavity that is fastened to the ground plane. The insulation cavity includes a fluid and a metal part. The metal part moves along an inner wall of the insulation cavity in the fluid as the antenna structure moves.

### CROSS-REFERENCE TO RELATED APPLICATIONS

This application is a continuation of International Application No. PCT/CN2024/088610, filed on Apr. 18, 2024, which claims priority to Chinese Patent Application No. 202310572248.4, filed on May 19, 2023. The disclosures of the aforementioned applications are hereby incorporated by reference in their entireties.

### TECHNICAL FIELD

Embodiments of this application relate to the antenna field, and more specifically, to an antenna structure and a communication device.

### BACKGROUND

Generally, a specific antenna can receive only a beam in a specific direction in space or radiate a beam in a specific direction to space. However, different environments in which the antenna is located may cause a deviation between a main radiation direction of the antenna and an expected direction, thereby affecting communication quality. To meet different communication requirements, the antenna needs to adjust a radiation pattern shape or a radiation direction of the antenna based on an environment in which the antenna is located.

Beam steering is a technology that can change a direction of a main lobe of an antenna to an expected direction, and is widely used in current wireless communication and radar technologies. Conventional antennas mostly use mechanical or electrical control to rotate beams to fixed beams or specific directions. For example, the main lobe can be steered by an electronic phase shift circuit to be deflected to the specific direction.

However, the phase shift circuit is complex, and involves a large quantity of electronic components, leading to high manufacturing complexity.

### SUMMARY

Embodiments of this application provide an antenna structure and a communication device, to automatically adjust a main radiation direction of the antenna structure based on an environment in which the antenna structure is located.

According to a first aspect, an antenna structure is provided. The antenna structure includes: a printed circuit board PCB, where the PCB includes a ground plane, and a feed part is disposed on the PCB; and an insulation cavity, where the insulation cavity is fastened to the PCB, the insulation cavity includes a fluid and a metal part, and the metal part moves along an inner wall of the insulation cavity in the fluid as the antenna structure moves.

In the antenna structure provided in this embodiment of this application, the insulation cavity, the fluid, and the metal part form a dielectric resonator that is configured to form a first resonance of the antenna structure. The metal part moves in the insulation cavity as the antenna structure moves. The metal part is subjected to gravity and buoyancy in the fluid, resulting in a resultant force that always points to a vertical direction. Therefore, a main radiation direction of the antenna can be guided to be near the vertical direction, to implement an effect of automatically adjusting the main radiation direction of the antenna.

In some embodiments, the insulation cavity may not include the fluid, and air (or another gas) in the insulation cavity, the insulation cavity, and the metal part are used as radiators for generating the first resonance.

The antenna structure provided in this application may be fed in a plurality of manners. For example, the antenna structure may be fed through a monopole probe, a microstrip slot, a microstrip patch, a coaxial line, or the like.

The PCB may further include a substrate. The substrate may be disposed on a side that is of the ground plane and that is away from the insulation cavity or on a side that is of the ground plane and that is close to the insulation cavity. A feeder device like a microstrip line, a microstrip patch, or a metal probe may be disposed on the substrate of the PCB, to feed the antenna structure.

With reference to the first aspect, in some embodiments of the first aspect, the inner wall of the insulation cavity includes a smooth curved surface.

When the inner wall of the insulation cavity is a smooth curved surface, it is convenient for the metal part in the insulation cavity to freely move along the inner wall of the insulation cavity under action of gravity and buoyancy.

With reference to the first aspect, in some embodiments of the first aspect, the curved surface is a spherical cap.

The spherical cap may be a curved surface formed by removing a partial area of a spherical surface. The spherical cap may be a hemispherical surface, or may be a curved surface greater than or less than a hemisphere.

In some embodiments, the curved surface may alternatively be a spherical surface.

With reference to the first aspect, in some embodiments of the first aspect, the insulation cavity includes an insulation cavity top, the insulation cavity top is a plane, and the insulation cavity top is fastened to the PCB.

When the insulation cavity top is a plane, it is convenient to fasten the insulation cavity to the PCB in the antenna structure.

With reference to the first aspect, in some embodiments of the first aspect, the metal part is spherical.

The spherical metal part may be a solid metal sphere or a hollow metal sphere.

In some embodiments, the metal part may alternatively be any polyhedral metal part or another regular or irregular metal part.

With reference to the first aspect, in some embodiments of the first aspect, the insulation cavity, the fluid, and the metal part are configured to form a first resonance of the antenna structure, a slot is provided in the ground plane, and the slot is configured to form a second resonance of the antenna.

The second resonance may be formed through the slot. In addition, a resonance frequency of the first resonance and a resonance frequency of the second resonance may be adjusted in various manners, so that the antenna structure can meet requirements of different scenarios.

In an embodiment, the slot used for forming the second resonance of the antenna may be a feed slot of the dielectric resonator formed by a container, the fluid, and the metal part. In this case, a projection of the insulation cavity on the PCB at least partially covers the slot.

In another embodiment, the dielectric resonator may be fed through another slot, and the slot may be configured to form a second resonance. Certainly, the slot used for feeding the dielectric resonator may alternatively form another resonance.

With reference to the first aspect, in some embodiments of the first aspect, the slot includes a first slot and a second slot, a length of the first slot is less than a length of the second slot, and widths of two ends of the first slot are greater than a width of a middle part of the first slot.

The second slot may be a radiator for second radiation, and the first slot may be mainly used for adjusting impedance matching of the antenna. Impedance matching of the antenna can be improved through widened two ends of the first slot.

With reference to the first aspect, in some embodiments of the first aspect, a substrate layer is disposed between the insulation cavity and the PCB, and the insulation cavity is fastened to the PCB through the substrate layer.

For the first resonance, in one aspect, a height of the dielectric resonator can be increased by disposing the substrate layer, so that a frequency of the first resonance shifts toward a lower frequency. In another aspect, a clearance area between the PCB and the dielectric resonator can be increased, so that the first resonance shifts toward a higher frequency. In still another aspect, an equivalent relative dielectric constant of the dielectric resonator can be adjusted by setting a relative dielectric constant of the substrate layer, and consequently the first resonance is affected.

For the second resonance, the substrate layer can change an equivalent relative dielectric constant of the PCB, to affect the second resonance.

Therefore, the substrate layer can affect both the first resonance and the second resonance, to expand a bandwidth of the antenna structure.

With reference to the first aspect, in some embodiments of the first aspect, the PCB is disposed above the insulation cavity, and gravity of the metal part is greater than buoyancy of the metal part in the fluid.

In this embodiment, the metal part can move along a bottom of the insulation cavity, and finally is stabilized at a lowest point of the bottom. A main radiation direction of the antenna is mainly a vertical downward direction. The antenna may be used in an indoor ceiling, an uncrewed aerial vehicle, a top of a large ship, or the like, to provide wireless resource coverage for a device below a mounting position of the antenna structure.

With reference to the first aspect, in some embodiments of the first aspect, the PCB is disposed below the insulation cavity, and the gravity of the metal part is less than the buoyancy of the metal part in the fluid.

In this embodiment, the metal part is always located at a highest point at the top of the insulation cavity, so that a main radiation direction of the antenna is approximately a vertical upward direction. The antenna may be mounted on, for example, a vehicle or a mobile terminal device. In this way, communication between the vehicle or the mobile terminal device and a network device like a base station is smoother in a movement process of the vehicle or the mobile terminal device.

With reference to the first aspect, in some embodiments of the first aspect, a relative dielectric constant of the insulation cavity is greater than 1.

With reference to the first aspect, in some embodiments of the first aspect, a relative dielectric constant of the fluid ranges from 3 to 200.

The relative dielectric constant of the fluid may be set according to a requirement. For example, when a volume of the insulation cavity is large, the relative dielectric constant of the fluid may be set to be large. If a volume of the insulation cavity is small, the relative dielectric constant of the fluid may be set to be small.

According to a second aspect, a communication device is provided. The communication device includes the antenna structure according to the first aspect or any implementation of the first aspect.

According to a third aspect, a vehicle is provided. The vehicle includes the antenna structure according to the first aspect or any implementation of the first aspect.

According to a fourth aspect, a terminal device is provided. The terminal device includes the antenna structure according to the first aspect or any implementation of the first aspect.

### BRIEF DESCRIPTION OF DRAWINGS

FIG. 1 is a diagram of a scenario in which an antenna structure is used;

FIG. 2 is a diagram of an antenna structure according to an embodiment of this application;

FIG. 3 is a diagram of a slot according to an embodiment of this application;

FIG. 4 is a diagram of an antenna structure in which a substrate layer is disposed according to an embodiment of this application;

FIG. 5 shows electric field simulation diagrams of an antenna structure in the absence and presence of a metal part;

FIG. 6 shows patterns of an antenna structure in the absence and presence of a metal part;

FIG. 7 is an electric field simulation diagram and a radiation pattern of an antenna structure at different offset angles;

FIG. 8 is an S parameter simulation diagram of an antenna structure at different offset angles;

FIG. 9 is a simulation diagram of an antenna structure with different slots; and

FIG. 10 shows simulation diagrams of an antenna structure in the absence and presence of a substrate layer.

### DESCRIPTION OF EMBODIMENTS

The following describes technical solutions of embodiments of this application with reference to accompanying drawings.

Terms used in the following embodiments are merely intended to describe specific embodiments, but are not intended to limit this application. Terms “one”, “a”, “the”, “the foregoing”, “this”, and “the one” of singular forms used in this specification and the appended claims of this application are also intended to include expressions such as “one or more”, unless otherwise specified in the context clearly. It should be further understood that in the following embodiments of this application, “at least one” and “one or more” mean one, two, or more. “First”, “second”, and various numbers are merely intended for distinguishing for ease of description, and are not intended to limit the scope of embodiments of this application. The character “/” generally indicates an “or” relationship between the associated objects. Sequence numbers of the following processes do not mean an execution sequence. The execution sequence of the processes should be determined based on functions and internal logic of the processes, and shall not constitute any limitation on an implementation process of embodiments of this application. For example, in embodiments of this application, expressions such as “110”, “210”, and “310” are merely identifiers for ease of description, and are not intended to limit a sequence of performing steps.

Reference to “an embodiment”, “some embodiments”, or the like described in embodiments of this application means that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all 10 of embodiments”, unless otherwise specifically emphasized in another manner. The terms “include”, “have”, and their variants all mean “include but are not limited to”, unless otherwise specifically emphasized in another manner.

The following describes terms that may appear in embodiments of this application.

In this application, “within a range of”, “a-b”, or “a˜b” is used, except when it is separately specified that no end value is included, end values at both ends of the range are included by default. For example, within a range from 1 to 5, two values 1 and 5 are included, and the values 1-5 or 1 to 5 include 1 and 5.

Coupling: The coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction of components; or may be understood as a form in which different components in a line structure are connected through a physical line that may transmit an electrical signal, for example, a copper foil or a conductive wire of a printed circuit board (PCB). The “indirect coupling” may be understood as electrical conduction of two conductors through air or without contact.

Radiator: The radiator is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator via a feeder. The radiator converts the energy into polarized electromagnetic wave energy and radiates the energy in a required direction. A receive radiator converts polarized electromagnetic wave energy from a direction of space into modulated high-frequency current energy, and transmits the modulated high-frequency current energy to an input end of a receiver via a feeder.

The radiator may include a conductor with a shape and size, for example, a linear radiator or a sheet-like radiator. A shape is not limited in this application. In an embodiment, the linear radiator may be referred to as a wire antenna for short. In an embodiment, the sheet-like radiator may include a microstrip antenna or a patch antenna. In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. The sheet-like radiator is in a shape of a circle, a rectangle, a loop, or the like. A shape is not limited in this application. A structure of the microstrip antenna usually includes a dielectric substrate, a radiator, and a ground plane, where the dielectric substrate is disposed between the radiator and the ground plane.

The radiator may also include a slot or a slit formed on a conductor, for example, a closed or semi-closed slot or slit formed on a grounded conductor surface. In an embodiment, a radiator with a slot or a slit may be referred to as a slot antenna or a slotted antenna for short. In an embodiment, a radiator with a closed slot or slit may be referred to as a closed slot antenna for short. In an embodiment, a radiator with a semi-closed slot or slit (for example, an opening is additionally provided on the closed slot or slit) may be referred to as an open slot antenna for short. In some embodiments, the slit is long bar-shaped. In some embodiments, a length of the slit is approximately half the wavelength (for example, the dielectric wavelength). In some embodiments, a length of the slit is approximately an integer multiple of the wavelength (for example, a one-fold dielectric wavelength). In some embodiments, the slit may be used for feeding through a transmission line bridged on one side or two sides of the slit. In this way, a radio frequency electromagnetic field is excited on the slit, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced apart from the ground plane and is grounded at two ends of the radiator, to form a closed or semi-closed slot or slit. In an embodiment, the radiator of the slot antenna or the slotted antenna may be implemented by a bracketed conductor that is grounded at both ends, and may also be referred to as a bracketed antenna.

The radiator may also include a solid or liquid medium. For example, a dielectric resonator antenna radiates through the entire resonator surface (except a surface in contact with the ground plane). The medium used by a dielectric resonator may be a liquid medium or a solid medium.

A feed unit (feed part)/feed circuit/feed structure is a combination of all components of an antenna for receiving and transmitting radio frequency waves. In a case of a receive antenna, the feed unit may be considered as an antenna part from a first amplifier to a front-end transmitter. In a transmit antenna, the feed unit may be considered as a part after a last power amplifier. In some cases, the “feed unit” is understood in a narrow sense as a radio frequency chip, or includes a transmission path from the radio frequency chip to a radiator or a feed point on a transmission line. The feed unit has a function of converting a radio wave into an electrical signal and sending the electrical signal to a receiver component. Usually, the feed unit is considered as a part of the antenna, and is configured to convert a radio wave into an electrical signal, and vice versa. When the antenna is designed, maximum power transmission value and efficiency need to be considered. Therefore, a feed impedance of the antenna shall match a load resistance. The feed impedance of the antenna is a combination of a resistance, a capacitance, and an inductance. To ensure a maximum power transmission condition, two impedances (the load resistance and the feed impedance) need to match. The matching can be completed by considering a frequency requirement and a design parameter (for example, a gain, directivity, and radiation efficiency) of the antenna.

End/Point: An “end/point” in a first end/second end/feed end/ground end/feed point/ground point/connection point of an antenna radiator cannot be understood in a narrow sense as an endpoint or an end part that is physically disconnected from another radiator, and may also be considered as a point or a section on a continuous radiator. In an embodiment, the “end/point” may include a connection/coupling area that is on the antenna radiator and that is coupled to another conductive structure. For example, the feed end/feed point may be a coupling area (for example, an area opposite to a part of the feed circuit) that is on the antenna radiator and that is coupled to the feed structure or the feed circuit. For another example, the ground end/ground point may be a connection/coupling area that is on the antenna radiator and that is coupled to a ground structure or a ground circuit.

Resonance/resonance frequency: The resonance frequency is also referred to as a resonant frequency. The resonance frequency may be a frequency at which an imaginary part of an input impedance of an antenna is zero. The resonance frequency may have a frequency range, namely, a frequency range in which a resonance occurs. A frequency corresponding to a strongest resonance point is a center frequency point frequency. A return loss of the center frequency may be less than −20 dB.

Resonance frequency band/communication frequency band/operating frequency band: Regardless of a type of antenna, the antenna always operates within a specific frequency range (a frequency bandwidth). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna.

Total efficiency of an antenna: The total efficiency of the antenna is a ratio of input power to output power at an antenna port.

Radiation efficiency of an antenna: The radiation efficiency of the antenna is a ratio of power radiated by the antenna to space (namely, power that is effectively converted into an electromagnetic wave) to active power input to the antenna. Herein, active power input to the antenna=input power of the antenna-loss power. The loss power mainly includes return loss power and metal ohmic loss power and/or dielectric loss power. The radiation efficiency is a value for measuring a radiation capability of the antenna. Both a metal loss and a dielectric loss are factors that affect the radiation efficiency.

A person skilled in the art may understand that efficiency is usually indicated by a percentage, and there is a corresponding conversion relationship between the efficiency and dB. Efficiency closer to 0 dB indicates better efficiency of the antenna.

Antenna pattern: The antenna pattern is also referred to as a radiation pattern, is a pattern in which relative field strength (a normalized modulus value) of a radiation field of an antenna changes with a direction at a specific distance from the antenna (a far field), and is usually represented by two plane patterns that are perpendicular to each other in a maximum radiation direction of the antenna.

The antenna pattern usually includes a plurality of radiation beams. A radiation beam with highest radiation intensity is referred to as a main lobe, and the other radiation beams are referred to as minor lobes or side lobes. In the minor lobes, a minor lobe in an opposite direction of the main lobe is also referred to as a back lobe.

Antenna return loss: The antenna return loss may be understood as a ratio of power of a signal reflected back to an antenna port through an antenna circuit to transmit power of the antenna port. A smaller reflected signal indicates a greater signal radiated by the antenna to space and higher radiation efficiency of the antenna. A greater reflected signal indicates a smaller signal radiated by the antenna to space and lower radiation efficiency of the antenna.

The antenna return loss may be represented by an S11 parameter, and S11 is one of S parameters. S11 indicates a reflection coefficient, and the parameter can indicate transmit efficiency of the antenna. The S11 parameter is usually a negative number. A smaller S11 parameter indicates a smaller antenna return loss, and less energy reflected back by the antenna. In other words, more energy that actually enters the antenna indicates higher total efficiency of the antenna. A greater S11 parameter indicates a greater antenna return loss and lower total efficiency of the antenna.

It should be noted that, an S11 value of −6 dB is usually used as a standard in engineering. When an S11 value of the antenna is less than −6 dB, it may be considered that the antenna can operate normally, or it may be considered that transmit efficiency of the antenna is high.

Ground (or ground plane) (GND): The ground (or ground plane) may generally be at least a part of any grounding plane, grounding plate, grounding metal layer, or the like in an electronic device (like a mobile phone), or at least a part of any combination of the foregoing grounding plane, grounding plate, ground component, or the like. The “ground” may be configured to ground components in the electronic device. In an embodiment, the “ground” may be a grounding plane of a circuit board of the electronic device, or may be a grounding plate formed by a middle frame of the electronic device or a grounding metal layer formed by a metal film below a screen of the electronic device. In an embodiment, the circuit board may be a printed circuit board (PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a grounding plane, and a trace layer. The trace layer and the grounding plane are electrically connected to each other through a via. In an embodiment, components such as a display, a touchscreen, an input button, a transmitter, a processor, a memory, a battery, a charging circuit, and a system-on-chip (system-on-chip, SoC) structure may be mounted on or connected to the circuit board, or electrically connected to the trace layer and/or the grounding plane in the circuit board. For example, a radio frequency source is disposed on the trace layer.

Any of the foregoing grounding plane, grounding plate, or grounding metal layer is made of a conductive material. In an embodiment, the conductive material may be any one of the following materials: copper, aluminum, stainless steel, brass and an alloy thereof, copper foil on an insulation substrate, aluminum foil on the insulation substrate, gold foil on the insulation substrate, silver-plated copper, silver-plated copper foil on the insulation substrate, silver foil on the insulation substrate, tin-plated copper, cloth impregnated with graphite powder, a graphite-coated substrate, a copper-plated substrate, a brass-plated substrate, and an aluminum-plated substrate. A person skilled in the art may understand that the grounding plane/grounding plate/grounding metal layer may alternatively be made of another conductive material.

Grounding: The grounding is coupling with the ground/ground plane in any manner. In an embodiment, the grounding may be grounding via an entity, for example, grounding via an entity (or referred to as entity grounding) at a specific position on a side frame is implemented through some mechanical parts of a middle frame. In an embodiment, the grounding may be grounding through a component, for example, grounding through a component (or referred to as component grounding) like a capacitor/inductor/resistor connected in series or in parallel.

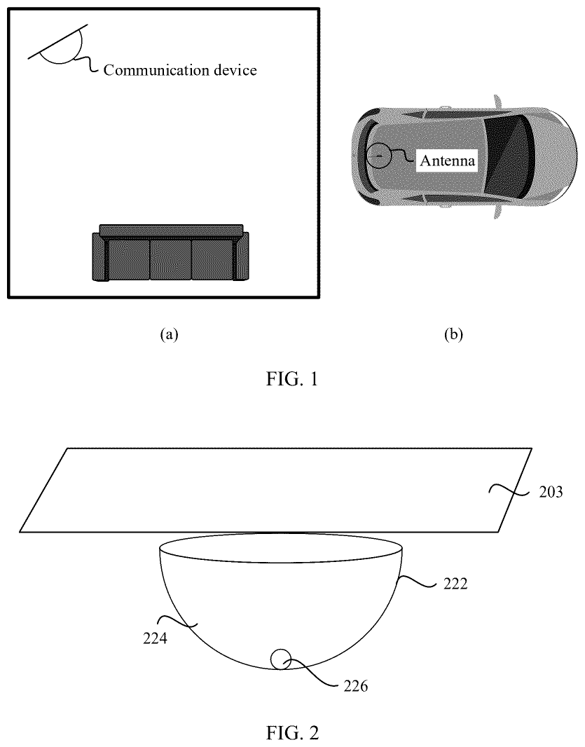

FIG. 1 shows two application scenarios of an antenna structure.

As shown in (a) in FIG. 1, when a communication device including an antenna structure is installed, due to a limitation of an installation environment, an installation angle of the communication device may be different from a preset angle, and a main radiation direction of an antenna may also be different from an expected radiation direction. This affects communication quality between the communication device and another device. For example, the communication device needs to be installed on a ceiling. Due to unevenness of the ceiling, the expected radiation direction changes after the communication device is installed. This may adversely affect communication quality of the communication device.

The antenna structure may be further installed in a mobile environment. As shown in (b) in FIG. 1, when the antenna structure is installed on a vehicle, due to movement of the vehicle, a radiation direction of the antenna may change greatly when the vehicle climbs a slope or travels on a concave road section. This affects communication quality of the vehicle.

The vehicle may be a car, a truck, a motorcycle, a bus, a boat, a plane, a helicopter, a lawn mower, a recreational vehicle, an amusement park vehicle, a construction device, a tram, a golf cart, a train, a trolley, an uncrewed aerial vehicle, or the like. This is not specifically limited in embodiments of this application.

Beam steering is a technology that can change a direction of a main lobe of the antenna to an expected direction, and is widely used in current wireless communication and radar technologies. Conventional antennas mostly use mechanical or electrical control to rotate beams to fixed beams or specific directions. For example, the main lobe can be steered by an electronic phase shift circuit to be deflected to the specific direction. When the antenna structure is in different environments, for example, antenna structures of a same type are installed in different environments, or the antenna structure is installed on a mobile device. The main radiation direction of the antenna may be steered to the expected direction through beam steering. For example, for a scenario shown in (a) in FIG. 1, a main radiation direction of the antenna structure may be always located near a vertical direction through mechanical or electrical control, to minimize the communication quality being affected when an installation environment does not meet a requirement. Alternatively, for a scenario shown in (b) in FIG. 1, the main radiation direction of the antenna structure may not change with a change of an angle of a vehicle body, but is always located near the vertical direction, to improve vehicle communication quality.

However, the phase shift circuit is complex, and involves a large quantity of electronic components, leading to high manufacturing complexity.

Embodiments of this application provide an antenna structure, to simply and effectively implement that a main radiation direction of an antenna can be automatically adjusted with an environment in which the antenna structure is located, and no complex element is involved.

FIG. 2 is a diagram of an antenna structure according to an embodiment of this application. As shown in FIG. 2, the antenna structure includes: a printed circuit board (PCB) 203, where the PCB 203 includes a ground plane, and a feed part (not shown in the figure) is disposed on the PCB 203; and an insulation cavity 222, where the insulation cavity 222 is fastened to the PCB 203, the insulation cavity 222 includes a fluid 224 and a metal part 226, and the metal part 226 moves along an inner wall of the insulation cavity 222 in the fluid 224 as the antenna structure moves.

According to the antenna structure shown in FIG. 2, the fluid 224, the metal part 226, and the insulation cavity 222 form a dielectric resonator, so that an electromagnetic wave is radiated to the outside through a surface of the insulation cavity 222 (except a surface that is of the insulation cavity 222 and that is in contact with the PCB 203). The dielectric resonator may be configured to generate a first resonance of the antenna structure. The metal part 226 moves along the inner wall of the insulation cavity 222 with movement of the antenna structure (for example, left-right shaking of the antenna structure). Due to a resultant force of gravity and buoyancy, the metal part 226 is always located at a lowest point on an inner surface that is of the insulation cavity 222 and that is away from the PCB 203. Therefore, the metal part 226 can direct radiation of the antenna structure to be near a vertical direction, so that a main radiation direction of the antenna structure is automatically adjusted.

In some embodiments, in this embodiment of this application, a metal layer or a metal plate may be separately disposed as a ground plane, instead of disposing a ground plane on the PCB. The feed part may also be correspondingly disposed based on an actual situation. The following mainly uses the PCB as an example to describe a main structure of the antenna structure in this embodiment of this application.

The antenna structure may be fed in a plurality of manners. For example, the antenna structure may be fed through a monopole probe, a microstrip patch, a microstrip slot, or the like. The PCB further includes a substrate. The monopole probe, the microstrip patch, or a microstrip line may be disposed on the substrate of the PCB together with another component. For example, when feeding is performed through the monopole probe, the substrate may be located on a side that is of the ground plane and that is away from the insulation cavity 222. The substrate may further have a hole through which the monopole probe passes. The monopole probe may extend to a first side of the PCB 203 through an opening on the PCB. The first side of the PCB 203 is a side that is of the PCB 203 and that is close to the insulation cavity 222. The monopole probe may extend into the fluid 224 in the insulation cavity 222, or may not extend into the fluid 224, but feed the antenna structure through coupling. In some embodiments, when feeding is performed through the monopole probe, the substrate may alternatively be disposed on a side that is of the ground plane and that is close to the insulation cavity 222. In this case, a hole through which the monopole probe passes does not need to be provided on the PCB. The monopole probe may directly extend into or not extend into the fluid 224. Alternatively, when feeding is performed through the microstrip patch, the substrate may be disposed on a side that is of the ground plane and that is close to the insulation cavity 222 (the substrate is disposed between the ground plane and the insulation cavity 222). The microstrip patch may be disposed on the substrate of the PCB and feed the antenna structure through coupling. Alternatively, when feeding is performed through the microstrip slot, the substrate may be disposed on a side that is of the ground plane and that is away from the insulation cavity 222 (the ground plane is disposed between the substrate and the insulation cavity 222). A slot is provided on the PCB 203, and the microstrip line is disposed at a position that is on the substrate and that corresponds to the slot of the PCB 203, to feed the antenna structure through coupling. In addition to the foregoing feeding manners, the antenna structure may have another feeding manner. Details are not described herein.

A size of the PCB 203 (a size of the ground plane) may be greater than a projection of the insulation cavity 222 on the PCB 203 in a direction perpendicular to the PCB 203, so that the antenna structure mainly radiates to a side that is of the PCB 203 and that is close to the insulation cavity 222. The substrate of the PCB 203 may be an FR-4 epoxy glass fiber cloth substrate, or may be a substrate made of another material.

The insulation cavity 222 may have inner walls of different shapes. For example, the inner wall may be in a spherical cap shape, so that the metal part 226 can smoothly slide on a surface of the spherical cap-shaped inner wall. In an embodiment, the spherical cap shape may be a hemisphere. The inner wall may alternatively be in another shape. The inner wall may form a smooth curved surface for the metal part to freely slide on the smooth curved surface. For example, the curved surface may be a rotational paraboloid, for example, an elliptical cap, an elliptical surface, an elliptical paraboloid, or other various smooth curved surfaces in regular or irregular shapes.

To facilitate fastening between the insulation cavity 222 and the PCB 203, the insulation cavity may include an insulation cavity top whose appearance is in a planar shape, and the insulation cavity top is fastened to the PCB 203. Certainly, the insulation cavity 222 may alternatively be a curved surface as a whole. For example, the insulation cavity may be in a spherical shell shape. This is not limited in this application.

A relative dielectric constant of the insulation cavity 222 (namely, a housing of the insulation cavity) may be greater than a relative dielectric constant (about 1) of air. For example, a material of the insulation cavity may be a material such as perspex acrylic or acrylic, with a relative dielectric constant of about 2.5.

The insulation cavity may have a uniform wall thickness. For example, a wall thickness of the insulation cavity may range from 1 mm to 5 mm. For example, the wall thickness of the insulation cavity may be 2 mm.

The size of the PCB 203 and the size of the insulation cavity 222 may be set according to a requirement. For example, when the antenna structure is disposed in a place with a high requirement for compact space, the size of the PCB 203 may be set to be small, for example, may range from 50 mm*50 mm to 200 mm*20 mm, and the size of the PCB 203 may be 75 mm*75 mm, 100 mm*100 mm, or the like.

The fluid 224 may be enclosed in an inner cavity of the insulation cavity 222. The fluid 224 may fill up the inner cavity of the insulation cavity 222, or may occupy different proportions of the inner cavity according to a requirement, for example, 20%, 40%, 60%, 80%, or 90%. In an embodiment, a proportion of the inner cavity occupied by the fluid 224 may enable the fluid 224 to cover a surface of the metal part 226 when the antenna structure is within a preset offset angle range. For example, when the antenna structure is offset within a range of ±30° in a vertical direction, the fluid 224 can cover the surface of the metal part 226. In this embodiment of this application, an included angle between a normal direction of the ground plane and the vertical direction may be referred to as an offset angle of the antenna structure. When the offset angle of the antenna structure is within the preset offset angle, an offset of an included angle between the main radiation direction of the antenna structure and the vertical direction may be less than a preset threshold. Alternatively, most radiation energy of the antenna structure may be within a specific angle range. For example, the preset offset angle of the antenna structure provided in this embodiment of this application may range from −90° to 90°, for example, may be ±60°, ±45°, or ±30°. In other words, when the offset angle of the antenna structure is ±60°, ±45°, or ±30°, the offset of the included angle between the main radiation direction of the antenna structure and the vertical direction is less than the preset threshold; or most radiation energy of the antenna structure is within a specific angle range (for example, within an included angle range of ±30° in the vertical direction).

A fluid 224 with a different relative dielectric constant may be used according to a requirement, and the relative dielectric constant of the fluid 224 may range from 3 to 200. For example, when the antenna structure needs to be miniaturized, a fluid with a large relative dielectric constant may be used, and the inner cavity of the insulation cavity 222 may alternatively be small. If the antenna structure occupies a large area, a fluid with a small relative dielectric constant may alternatively be used, and the inner cavity of the insulation cavity 222 may alternatively be large, to increase a radiation range of the antenna structure. For example, the relative dielectric constant of the fluid 224 may be 17, 60, 100, 30, or the like.

In some embodiments, a first fluid and a second fluid may be disposed in the insulation cavity 222. The first fluid and the second fluid are immiscible and have a density difference. In this way, an interface between the two fluids is perpendicular to the vertical direction, and proportions of the two fluids may be set to adjust an equivalent relative dielectric constant of the dielectric resonator, to control a frequency of the first resonance.

The metal part 226 may be in a spherical shape, a cylindrical shape, a regular polyhedron shape, or another irregular shape. The metal part 226 may be of a hollow structure or a solid structure, for example, a hollow spherical shell or a solid sphere. When the antenna structure operates, an electric field may be limited outside a surface of the metal part, and radiation of the antenna is guided by the metal part 226 to the vertical direction. A size of the metal part 226 and a size of the insulation cavity 222 may satisfy the following relationship: The size of the metal part 226 and the size of the insulation cavity 222 allow the metal part 226 to move freely along the inner wall of the insulation cavity 222 within the preset offset angle range of the antenna structure. For example, when the metal part 226 is spherical and the insulation cavity 222 is hemispherical, if a preset offset angle of the antenna structure is ±45°, a diameter of the metal ball may be less than 0.4 times a diameter of the insulation cavity 222.

In this embodiment of this application, a slot that generates a second resonance may be further disposed in the ground plane. The slot may be a slot for feeding the dielectric resonator of the antenna structure through coupling mentioned above, or may be a separate slot different from the slot used for feeding. The following mainly describes the technical solutions in embodiments of this application by using an example in which the slot is the slot for feeding the dielectric resonator through coupling mentioned above.

A shape of the slot in the ground plane may cause the slot to generate the second resonance. Because the slot needs to be used for feeding the dielectric resonator through coupling, a projection of the insulation cavity 222 on the PCB 203 covers at least the slot. A feed device like a patch antenna or a microstrip line may feed the slot through coupling, to form the second resonance. In this case, the insulation cavity 222, the metal part 226, and the fluid 224 form the first resonance as a radiator of the antenna structure, and the slot forms the second resonance as another radiator of the antenna structure.

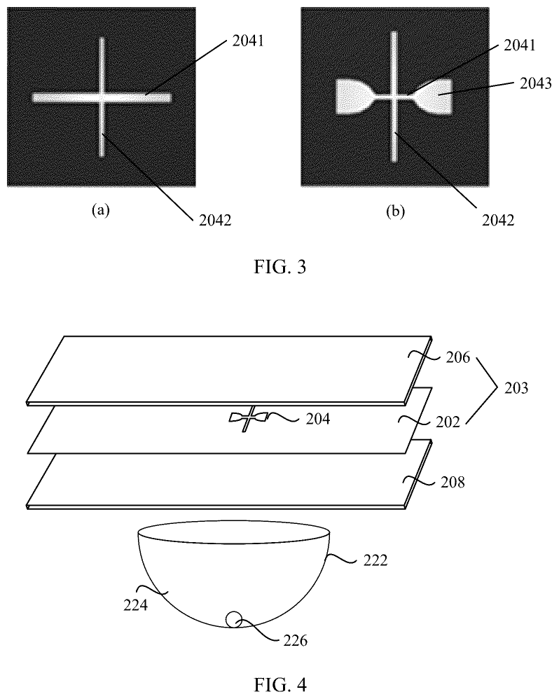

A frequency of the second resonance may be adjusted by adjusting a shape of the slot. For example, the frequency of the second resonance may be reduced by increasing a length of the slot to increase a length of a diffraction path of a current. For example, (a) in FIG. 3 is a diagram of a slot according to an embodiment of this application. The slot includes a first slot 2041 and a second slot 2042 that intersect each other. A length of the first slot 2041 and a length of the second slot 2042 may be different, and the frequency of the second resonance may be adjusted by setting the length of the first slot 2041 and the length of the second slot 2042. In addition, to improve an impedance matching degree of the antenna structure, a shape of the slot may be changed. (b) in FIG. 3 is a diagram of another slot according to this application. As shown in (b) in FIG. 3, a length of the first slot 2041 is less than a length of the second slot 2042, and widths of two ends 2043 of the first slot 2041 are greater than a width of a middle part of the first slot 2041, so that the entire slot 204 is in a bow-tie shape. (A width of the first slot 2041 may be understood as a size of the first slot 2041 in a direction perpendicular to an extension direction of the first slot 2041, and the length of the first slot 2041 or the second slot 2042 may be understood as a length in the extension direction of the first slot 2041 or the second slot 2042). Because the two ends 2043 of the first slot are widened to change current distribution, impedance matching of the antenna structure may be performed by adjusting shapes of the two ends of the first slot. The two ends 2043 of the first slot may be semicircular, elliptical, or in other regular or irregular shapes.

In this embodiment of this application, the frequency of the first resonance may be higher than or lower than the frequency of the second resonance. An operating bandwidth of the antenna structure may be expanded by using the first resonance and the second resonance.

To adjust an operating frequency of the antenna structure, a substrate layer may be disposed between the PCB 203 and the insulation cavity 222. The substrate layer may be a part of the PCB, or may be independent of the PCB. FIG. 4 is a diagram of an antenna structure in which a substrate layer is disposed according to an embodiment of this application. As shown in FIG. 4, the PCB 203 of the antenna structure includes a substrate 206 and a ground plane 202. The substrate 206 is disposed on a side that is of the ground plane 202 and that is away from the insulation cavity 222. The substrate layer 208 is disposed on a side that is of the PCB 203 and that is close to the insulation cavity 222. A slot 204 is disposed in the ground plane 202.

For a first resonance, in one aspect, an effective height of the insulation cavity 222 is increased by disposing the substrate layer 208, so that the first resonance shifts toward a lower frequency. In another aspect, a capacitive coupling effect between the PCB 203 and the dielectric resonator may be reduced, and a clearance area between the PCB 203 and the dielectric resonator is increased, so that the first resonance shifts toward a higher frequency. In still another aspect, an equivalent relative dielectric constant of the dielectric resonator can be adjusted by setting a relative dielectric constant of the substrate layer, and consequently the first resonance is affected. If the relative dielectric constant of the substrate layer is large, the first resonance may shift toward a lower frequency.

For a second resonance, an equivalent relative dielectric constant of the PCB 203 may be affected by disposing the substrate layer 208. If a relative dielectric constant of the substrate layer 208 is greater than a relative dielectric constant of the substrate 206, the equivalent relative dielectric constant of the PCB 203 is increased, and the second resonance shifts toward a lower frequency. If the relative dielectric constant of the substrate layer 208 is less than the relative dielectric constant of the substrate 206, the second resonance shifts toward a higher frequency.

In an embodiment, the relative dielectric constant of the substrate layer 208 may be less than the relative dielectric constant of the substrate 206. For example, the substrate layer 208 is made of polytetrafluoroethylene (PTFE, also known as Teflon^{TM}) material whose relative dielectric constant is less than a relative dielectric constant of a substrate material FR-4. In this way, the equivalent relative dielectric constant of the PCB 203 is reduced, and the second resonance shifts toward a higher frequency. For the first resonance, disposing the substrate layer 208 may shift the first resonance to a low frequency (for example, an effect of increasing the effective height of the insulation cavity 222 is large).

In this way, when a frequency of the first resonance is higher than a frequency of the second resonance, a difference between a frequency of a resonance point of the first resonance and a frequency of a resonance point of the second resonance is reduced, for example, may be within a threshold, and impedance of a high-impedance frequency band between the first resonance and the second resonance can be properly reduced, so that the first resonance and the second resonance jointly form an operating frequency band, to effectively expand an operating bandwidth of the antenna structure.

When the frequency of the first resonance is less than the frequency of the second resonance, operating frequency bands of the first resonance and the second resonance are further separated by disposing the substrate layer 208. If impedance of a high-impedance frequency band between the first resonance and the second resonance is not large, the two frequency bands are separated, so that an operating bandwidth of the antenna structure can also be expanded. Alternatively, if impedance of the high-impedance frequency band between the first resonance and the second resonance is large, the antenna structure provided in this embodiment of this application can operate at two different frequencies, so that application scenarios of the antenna structure provided in this embodiment of this application are increased.

In some embodiments, the relative dielectric constant of the substrate layer 208 may be greater than the relative dielectric constant of the substrate 206, so that the second resonance shifts toward a lower frequency, and the first resonance may shift toward a lower frequency due to an increase in an equivalent height of the insulation cavity. The relative dielectric constant of the substrate layer 208 is set according to different requirements, so that the frequency of the first resonance and the frequency of the second resonance can be conveniently adjusted. For details, refer to the foregoing descriptions. Details are not described herein again.

The substrate layer 208 may form a multilayer PCB board with the PCB, or may be disposed independently of the PCB board. This is not limited in this application.

The antenna structure provided in this embodiment of this application may be used in different scenarios. For example, when the antenna structure is disposed, the PCB 203 may be disposed above, and the insulation cavity 222 may be disposed below. Then, the metal part 226 always moves along a lower inner wall of the insulation cavity under an action of a resultant force of gravity and buoyancy in a fluid (the gravity is greater than the buoyancy) in the insulation cavity 222. A main radiation direction of the antenna structure is guided to be near a vertical downward direction. For example, the antenna structure may be disposed on a ceiling of a ship or an uncrewed aerial vehicle. When a posture of the ship or the uncrewed aerial vehicle changes, the main radiation direction of the antenna structure is always near the vertical downward direction, to provide communication coverage for a device on the ship and a device in a specific area within an activity range of the uncrewed aerial vehicle.

Alternatively, when the antenna structure is disposed, the PCB 203 is disposed below, and the insulation cavity 222 is disposed above. In addition, buoyancy of the metal part 226 in the fluid 224 is greater than gravity of the metal part 226 by setting density of the fluid 224, so that the metal part 226 moves along an inner wall on a side that is of the insulation cavity 222 and that is away from the ground plane 206 (a topmost position of the insulation cavity). In this case, the main radiation direction of the antenna structure is guided to be near the vertical upward direction. For example, the antenna structure may be disposed on a vehicle, so that in a scenario like a slope-climbing scenario of the vehicle, the main radiation direction of the antenna structure is always near the vertical upward direction, and communication quality between the vehicle and a communication device like a base station is improved.

An operating frequency band of the antenna structure provided in this embodiment of this application may be set according to a use requirement by controlling the first resonance (In some embodiments, and the second resonance). The operating frequency band of the antenna structure provided in this embodiment of this application may be less than 10 GHz, for example, may include 2 GHz to 2.5 GHz, 1525 MHz to 1625 MHz, or the like.

It should be understood that the antenna structure shown in FIG. 4 includes a substrate layer and a slot. The slot may feed the dielectric resonator and generate the second resonance. The dielectric resonator may also be disposed with an independent feed structure. Regardless of whether the ground plane includes the slot that generates the second resonance, the substrate layer may be disposed to adjust a resonance frequency of the antenna. In addition, because the slot needs to be used to feed the dielectric resonator, the ground plane is disposed between the substrate and the substrate layer. If the dielectric resonator is fed in another manner, positions of the substrate and the ground plane may be exchanged. For specific details, refer to the foregoing descriptions. Details are not described herein again.

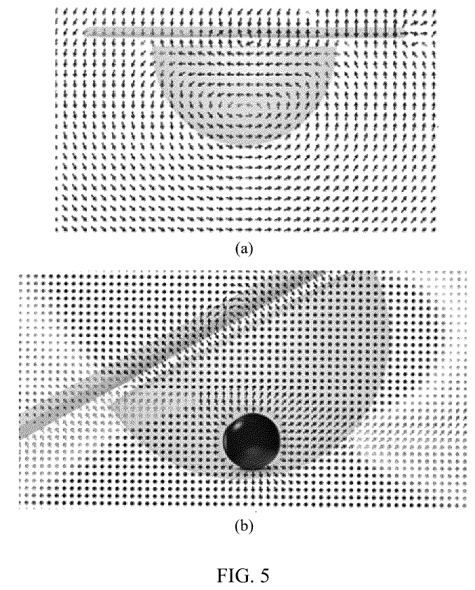

FIG. 5 to FIG. 10 show simulation results of the antenna structure provided in embodiments of this application.

To more clearly show a function of the metal part 226 in the antenna structure provided in embodiments of this application, FIG. 5 shows electric field distribution diagrams of the antenna structure corresponding to FIG. 2 or FIG. 4 in the absence and presence of a metal part 226. (a) in FIG. 5 is an electric field distribution diagram in a TE₁₁ mode in the absence of a metal part. It can be learned that in this case, electric field distribution of the antenna structure is symmetrical distribution based on a shape of the insulation cavity, and a radiation direction of the antenna structure is also in symmetrical distribution based on the shape of the insulation cavity. If the antenna structure tilts or a position of the antenna structure changes, a radiation direction changes with the antenna structure. For an electric field simulation diagram, electric field distribution of the antenna structure may change with a shape and a position of a feed point of the antenna structure, and may not be completely symmetrical distribution. For example, when the feed point is located on a symmetry axis of the antenna structure, the electric field distribution may be in a symmetrical shape shown in (a) in FIG. 5. (b) in FIG. 5 is an electric field distribution diagram of the antenna structure in the presence of a metal part. It can be learned that electric fields are distributed with the metal part. Because the metal part is always located at a lowest point in a vertical direction under action of gravity and buoyancy, a main radiation direction of the antenna structure is always near the vertical direction.

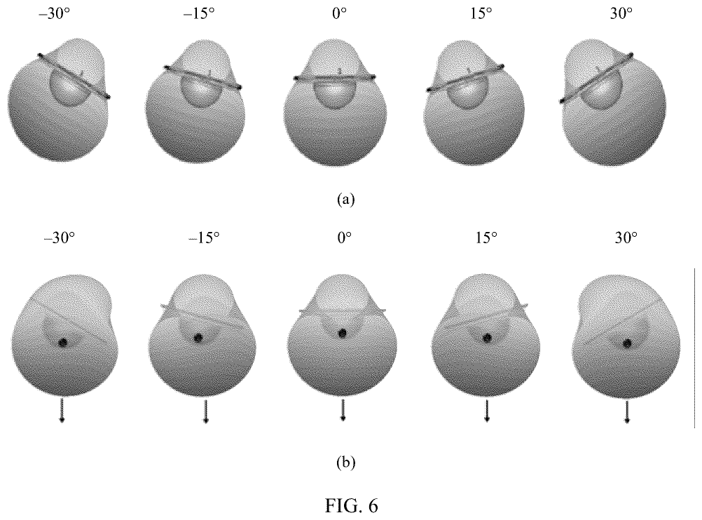

FIG. 6 shows patterns of the antenna structure corresponding to FIG. 2 or FIG. 4 in the absence and presence of a metal part. (a) in FIG. 6 is a pattern in the absence of a metal part. It can be learned that a main radiation direction of the antenna structure is on a side that is of the ground plane and that is close to the insulation cavity. When an offset angle of the antenna structure ranges from −30° to 30°, the main radiation direction of the antenna structure also changes. (b) in FIG. 5 is a pattern in the presence of a metal part. When an offset angle of the antenna structure ranges from −30° to 30°, a main radiation direction of the antenna structure is always near a vertical direction. The metal part guides the radiation direction of the antenna structure to be near the vertical direction, to implement automatic adjustment of the radiation direction of the antenna structure.

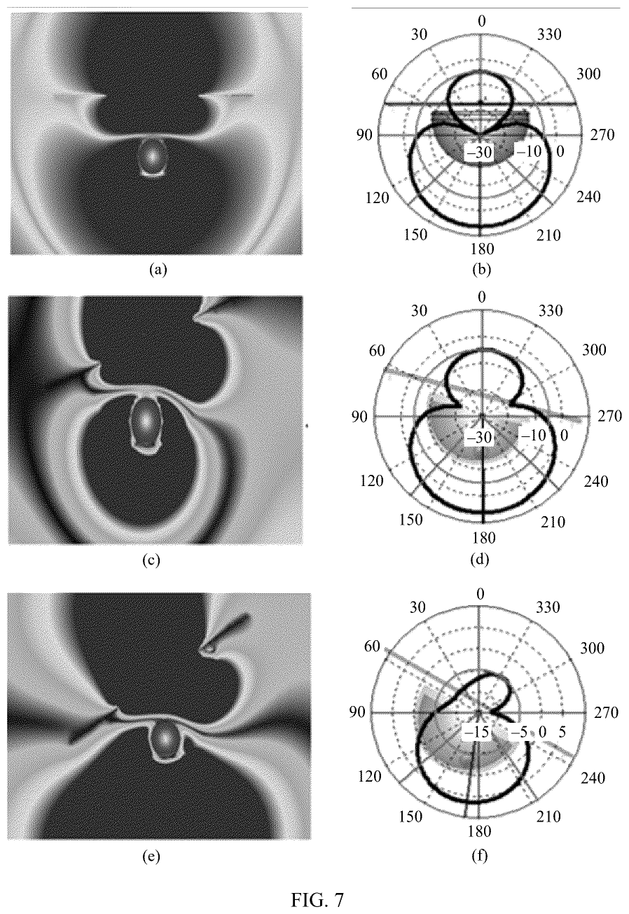

FIG. 7 shows electric field simulation diagrams and radiation patterns of the antenna structure shown in FIG. 2 or FIG. 4 when an offset angle is 0°, 15°, and 30°. (a) in FIG. 7 and (b) in FIG. 7 are respectively an electric field diagram and a radiation pattern of the antenna structure when the offset angle is 0°. (c) in FIG. 7 and (d) in FIG. 7 are respectively an electric field diagram and a radiation pattern of the antenna structure when the offset angle is 15°. (e) in FIG. 7 and (f) in FIG. 7 are respectively an electric field diagram and a radiation pattern of the antenna structure when the offset angle is 30°. It can be learned that both the electric field distribution and the radiation direction change with the offset angle of the antenna structure, so that the radiation direction of the antenna structure can be automatically adjusted.

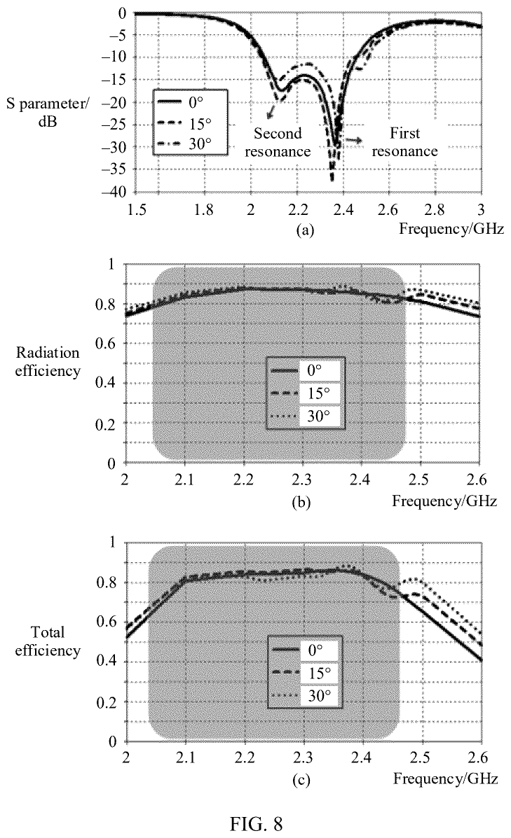

FIG. 8 shows an S parameter simulation diagram, a radiation efficiency simulation diagram, and a total efficiency simulation diagram of the antenna structure shown in FIG. 4 when an offset angle is 0°, 15°, and 30°. (a) in FIG. 8 is the S parameter simulation diagram, (b) in FIG. 8 is the radiation efficiency simulation diagram, and (c) in FIG. 8 is the total efficiency (total efficiency) simulation diagram. When the offset angle of the antenna structure changes from 0°to 30°, in a frequency band of 2 GHz to 2.5 GHz, a return loss is less than −10 dB, and a difference between total efficiency and radiation efficiency is not large. In other words, a change of the offset angle of the antenna structure has little impact on radiation effect of the antenna structure.

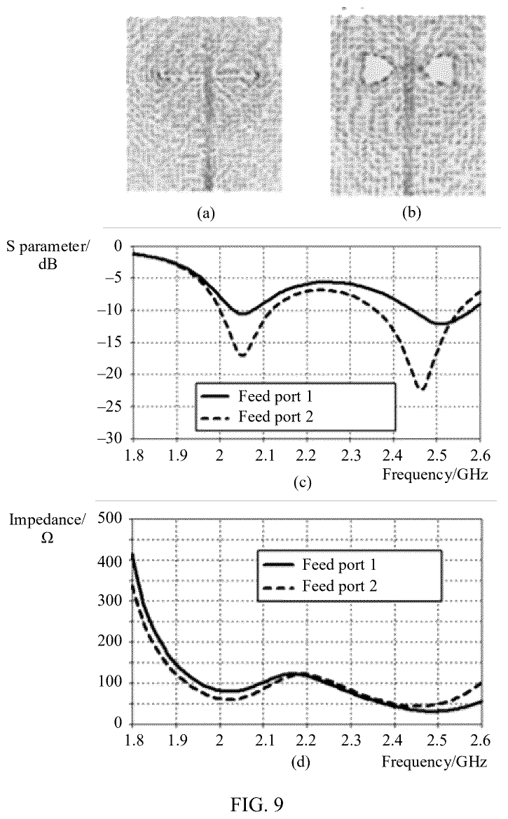

The antenna structure having the structure shown in FIG. 4 is used as an example. FIG. 9 shows current diagrams, an S parameter diagram, and an input impedance diagram of the antenna structure having a slot in (a) in FIG. 3 and (b) in FIG. 3. (a) in FIG. 9 and (b) in FIG. 9 are current distribution diagrams near the slot in the ground plane. (c) in FIG. 9 is an S parameter diagram of the antenna structure. Regardless of the slot, two resonance points can be seen in the S parameter diagram, which are respectively located near 2.05 GHz and 2.45 GHz. A resonance peak (the second resonance) generated by a corresponding slot is near 2.05 GHz and a resonance peak (the first resonance) generated by a corresponding dielectric resonator is near 2.45 GHz. A slot 1 is a cross-shaped slot corresponding to (a) in FIG. 3, and a slot 2 is a bow-tie-shaped slot corresponding to (b) in FIG. 3. When the antenna structure has the bow-tie-shaped slot, a return loss of the antenna structure in 2 GHz to 2.5 GHz is less than a return loss of the antenna structure having the cross-shaped slot. The bow-tie-shaped slot improves impedance matching of the antenna structure, so that the antenna structure has a better operating state. (d) in FIG. 9 is an input impedance diagram. Input impedance of the two slots does not change greatly in 2 GHz to 2.5 GHz. When the bow-tie-shaped slot is used, the input impedance is slightly reduced in a frequency band of 2 GHz to 2.2 GHz. This is mainly because a slot shape change greatly affects the second resonance.

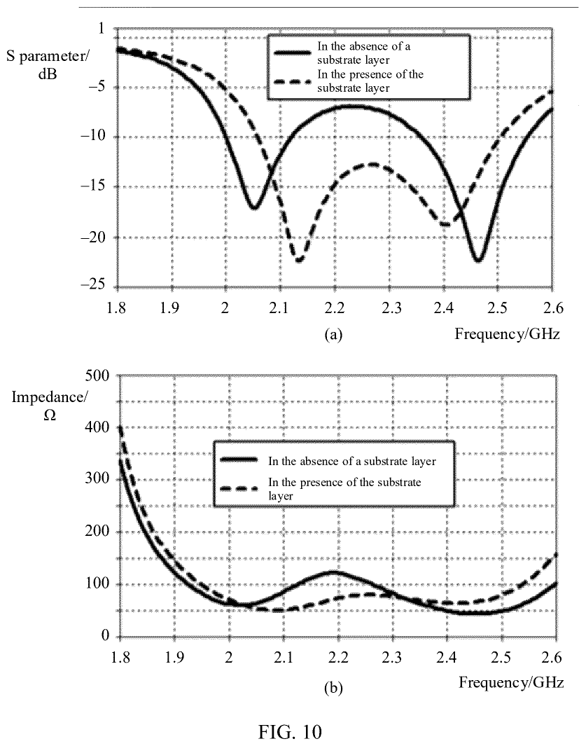

FIG. 10 shows impact on an S parameter and an input impedance of the antenna structure in the absence or presence of a substrate layer. It can be learned from (a) in FIG. 10 that, in the presence of the substrate layer, a frequency of a resonance point of a first resonance shifts toward a lower frequency, and is reduced from 2.47 GHz to 2.4 GHz. A frequency of a resonance point of a second resonance shifts toward a higher frequency, and shifts from 2.06 GHz to 2.12 GHz, so that in a range of 2 GHz to 2.5 GHz, a return loss in most frequency band ranges is reduced. In addition, the input impedance of the antenna structure is affected to a specific extent, and an input impedance of 2 GHz to 2.3 GHz is reduced. However, in a frequency band of 2.3 GHz to 2.5 GHz, the input impedance is improved.

In the several embodiments provided in this application, it should be understood that the disclosed system, apparatus, and method may be implemented in other manners. For example, the described apparatus embodiments are merely examples. For example, division into the units is merely logical function division. There may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna structure, comprising:
a printed circuit board (PCB) comprising a ground plane and a feed part; and
an insulation cavity fastened to the PCB, the insulation cavity comprising a fluid and a metal part moveable along an inner wall of the insulation cavity in the fluid as the antenna structure moves.

2. The antenna structure according to claim 1, wherein the inner wall of the insulation cavity comprises a smooth curved surface.

3. The antenna structure according to claim 2, wherein the curved surface is a spherical cap.

4. The antenna structure according to claim 1, wherein the insulation cavity comprises an insulation cavity top, the insulation cavity top is a plane, and the insulation cavity top is fastened to the PCB.

5. The antenna structure according to claim 1, wherein the metal part is spherical.

6. The antenna structure according to claim 1, wherein the insulation cavity, the fluid, and the metal part are configured to form a first resonance of the antenna structure, a slot is provided in the ground plane, and the slot is configured to form a second resonance of the antenna structure.

7. The antenna structure according to claim 6, wherein the slot comprises a first slot and a second slot, a length of the first slot is less than a length of the second slot, and widths of two ends of the first slot are greater than a width of a middle part of the first slot.

8. The antenna structure according to claim 1, wherein a substrate layer is disposed between the insulation cavity and the PCB, and the insulation cavity is fastened to the PCB through the substrate layer.

9. The antenna structure according to claim 1, wherein the PCB is disposed above the insulation cavity, and gravity of the metal part is greater than buoyancy of the metal part in the fluid.

10. The antenna structure according to claim 1, wherein the PCB is disposed below the insulation cavity, and gravity of the metal part is less than buoyancy of the metal part in the fluid.

11. The antenna structure according to claim 1, wherein a relative dielectric constant of the insulation cavity is greater than 1.

12. The antenna structure according to claim 1, wherein a relative dielectric constant of the fluid ranges from 3 to 200.

13. A communication device comprising:
an antenna structure, wherein the antenna structure comprises:
a printed circuit board (PCB) comprising a ground plane and a feed part; and
an insulation cavity, wherein the insulation cavity is fastened to the PCB, the insulation cavity comprises a fluid and a metal part, and the metal part moves along an inner wall of the insulation cavity in the fluid as the antenna structure moves.

14. The communication device according to claim 13, wherein the inner wall of the insulation cavity comprises a smooth curved surface.

15. The communication device according to claim 13, wherein the insulation cavity comprises an insulation cavity top, the insulation cavity top is a plane, and the insulation cavity top is fastened to the PCB.

16. The communication device according to claim 13, wherein the insulation cavity, the fluid, and the metal part are configured to form a first resonance of the antenna structure, a slot is provided in the ground plane, and the slot is configured to form a second resonance of the antenna structure.

17. The communication device according to claim 16, wherein the slot comprises a first slot and a second slot, a length of the first slot is less than a length of the second slot, and widths of two ends of the first slot are greater than a width of a middle part of the first slot.

18. The communication device according to claim 13, wherein the PCB is disposed above the insulation cavity, and gravity of the metal part is greater than buoyancy of the metal part in the fluid; or wherein the PCB is disposed below the insulation cavity, and the gravity of the metal part is less than the buoyancy of the metal part in the fluid.

19. The communication device according to claim 13, wherein a relative dielectric constant of the insulation cavity is greater than 1.

20. The communication device according to claim 13, wherein a relative dielectric constant of the fluid ranges from 3 to 200.
